(19) United States
(12) Patent Application Publication
(10) Pub. No.: US 2023/0093584 A1
(43) Pub. Date: Mar. 23, 2023

(54) Method for preparing NdFeB magnets including lanthanum or cerium

(71) Applicant: Yantai Dongxing Magnetic Materials Inc., Yantai (CN)

(72) Inventors: Xiulei CHEN, Yantai (CN); Zhongjie PENG, Yantai (CN); Zhanji DONG, Yantai (CN); Kaihong DING, Yantai (CN)

(21) Appl. No.: 17/946,046

(22) Filed: Sep. 16, 2022

(30) Foreign Application Priority Data
Sep. 16, 2021 (CN) 202111089037.2

(51) Int. Cl. H01F 1/057; H01F 41/02; B22F 1/14; C22C 38/00; B22F 3/24; B22F 1/05

(52) U.S. Cl. CPC H01F 1/0577; H01F 41/0253; B22F 1/14; C22C 38/005; C22C 38/001; B22F 3/24; B22F 1/05; B22F 2304/10; B22F 2202/05; B22F 2301/355; C22C 2202/02; B22F 9/04

(57) ABSTRACT

The disclosure refers to a method for preparing NdFeB magnets including at least one of Ce and La. The method includes:

S1) Separately preparing flakes of alloy R1 and flakes of alloy R2 each by a strip casting process, wherein the alloy R1 includes at least one of La and Ce, but the alloy R2 does not include La and Ce;
S2) separately subjecting the flakes of alloy R1 and R2 to a hydrogen embrittlement process followed by pulverizing the process product to alloy powders by jet milling, wherein a ratio of the average particle sizes D50 of the powder of alloy R1 and R2 satisfied formula:

0.32≤R2/R1≤0.66;

S3) mixing the powder of alloy R1 and R2; and
S4) subjecting the mixed powders to molding and magnetic field orientation, cold isostatic pressing, sintering, and an annealing process.

### CROSS-REFERENCE TO RELATED APPLICATIONS

This application is based on Chinese Patent Application No. 202111089037.2, filed Sep. 16, 2021, which claims the benefit of priority to the Chinese Patent Application, which is incorporated by reference in its entirety herein.

The present disclosure relates to a method for preparing NdFeB magnets including lanthanum or cerium.

### BACKGROUND

The addition of abundant light rare earths is an important measure for NdFeB magnets to reduce material costs. However, with a high proportion of commonly occurring rare earths, such as lanthanum and cerium, the magnetic properties are worse. Specifically, Nd2Fe14B has a Js(magnetic polarisation intensity) of 1.61 T and HA (magnetic anisotropic field) of 73kOe; Pr₂Fe₁₄B has a Js of 1.56 T and HA of 75kOe; La2Fe14B has a Js of 1.38 T and HA of 20kOe; and Ce₂Fe₁₄B has a Js of 1.17 T and HA of 26kOe. In order to reduce the negative influence of higher contents of lanthanum and cerium, a surface grain boundary diffusion or the intergranular addition of elements improving the magnetic properties is carried out in the industrial production process.

CN102800454A relates to a low-cost dual-phase Ce permanent magnet alloy and a corresponding preparing method. The magnetic properties are improved by forming Nd—Fe—B and (Ce, Re)—Fe—B phases. However, the Ha of the (Ce, Re)—Fe—B main phase is significantly lowered, which limits the improvement of magnetic properties.

CN106710768A discloses adding NdHₓ powder to form a hard magnetic layer of Nd in the outer layer of (Nd,Ce)FeB to improve the magnetic crystal anisotropic field, which effectively improves the coercive force. However, this method requires the preparation of three kinds of powders, and then the powder is mixed, and the process is more complicated. Moreover, dehydrogenation of the added NdHₓ should be taken into consideration during the sintering process, which increases the difficulty of the process.

CN102842400B discloses adding lanthanum and cerium powder for substituting the neodymium-rich phase. The lanthanum and cerium powder should be prepared by special process. The method may avoid too high lanthanum or cerium penetration into the mainphase of NdFeB magnet, and thus improves the product performance while reducing costs. However, lanthanum and cerium are the most active rare earth elements, and lanthanum cerium powder is very prone to oxidize and nitride formation, which affects the additive effect. Moreover, it is also difficult to prepare a lanthanum cerium powder.

### SUMMARY

The disclosure is defined by the appended claims. The description that follows is subjected to this limitation. Any disclosure lying outside the scope of said claims is only intended for illustrative as well as comparative purposes.

In particular, the present disclosure provides a preparation method for aNdFeB permanent magnet as defined in claim 1.

Further embodiments of the disclosure could be learned from the dependent claims and following description.

### BRIEF DESCRIPTION OF THE DRAWING

FIG. 1 is schematic diagram illustrating of diffusion processes during the manufacturing of a sintered NdFeBmagnet.

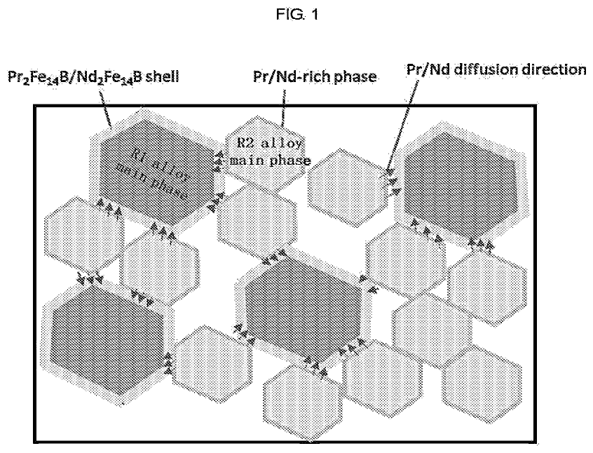

### DETAILED DESCRIPTION

Reference will now be made in detail to embodiments. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

General Concept ANdFeB magnet (also known as NIB or Neo magnet) is the most widely used type of rare-earth magnet. It is a permanent magnet made from an alloy of neodymium, iron, and boron to form the Nd₂Fe₁₄B tetragonal crystalline structure as a main phase. Besides, the microstructure of Nd—Fe—B magnets includes usually aNd-rich phase. The alloy may include further elements in addition to or partly substituting neodymium and iron. The present disclosure specifically refers to a process of manufacturing a sintered NdFeB magnet, which includes significant amounts of lanthanum (La) and/or cerium (Ce) as alloy components.

According to the present disclosure, there is provided a method for preparing (sintered type)NdFeB magnets including at least one of Ce and La. The method includes the following steps:

S1) Separately preparing flakes of alloy R1 and flakes of alloy R2 each by a strip casting process, wherein the alloy R1 includes at least one of La and Ce, but the alloy R2 does not include La and Ce;
S2) separately subjecting the flakes of alloy R1 and the flakes of alloy R2 to a hydrogen embrittlement process followed by pulverizing the process product to alloy powders by jet milling, wherein a ratio of the average particle sizes D50 of the powder of alloy R1 and the powder of alloy R2 satisfied formula: 0.32 R2/R1≤0.66;
S3) mixing the powder of alloy R1 and the powder of alloy R2; and
S4) subjecting the mixed powders to molding and magnetic field orientation, cold isostatic pressing, sintering, and an annealing process.

Thus, alloy R2 neither contains lanthanum nor cerium and thereby allows to form much more Nd-rich phase than alloy R1 during the manufacturing process. Further, the particles of alloy R2 can be easily attached on the surface on the larger particles of alloy R1 which contain lanthanum and cerium. The limitation of the particles size ratio of the particles of alloy R1 to particles of alloy R2 can induce a better coating effect. The Nd-rich phase of the attached smaller particles of alloy R2 may then penetrate into the outer sphere of Ce (La)-containing grains of the larger particles of alloy R1 during the sintering and annealing process. Thereby, a hard (or rigid) magnetic layer outside the bigger Ce (La)-containing grains may be formed. Said hard magnetic layer enhances the magnetic properties of the Ce (La)-containing main phase and negative effects caused by presence of La and Ce are avoided or at least reduced.

In steps S1 and S2 of the disclosed manufacturing process, alloy flakes and alloy powders having two different compositions are separately prepared from each other. Specifically, NdFeB alloy flakes are produced by a strip casting process (for example, using a vacuum induction furnace), then subjected to a hydrogen embrittlement process (i.e. hydrogen absorption and dehydrogenation), followed by jet milling for preparing the desired NdFeB magnet powders. The strip casting process, the hydrogen embrittlement process, and the jet milling process are currently well-known technologies.

The freshly produced alloy powders are used for preparing the sintered NdFeB magnet in steps S3 and S4. Cold isostatic pressing of the mixed alloy powders to a green compact while applying a magnetic field for orientation is also state of the art. In other words, the process up to the preparing of a green compact is well-known in the art. Furthermore, sintering and annealing of the green compact may be done similar to commonly known process conditions.

According to one embodiment, a total content of La and Ce in alloy R1 is 6.0 to 20.0 wt. %.

According to another embodiment, which may be combined with the afore-mentioned embodiment, a total content of rare earth elements in alloy R1 is 29.0 to 31.0 wt. %.

According to another embodiment, which may be combined with any one the afore-mentioned embodiments, a total content of rare earth elements in alloy R2 is 33.10 to 35.00 wt. %.

Specifically, a composition of alloy R1 can be set to REₐLC_{X}T_{(1-abc)}B_{b}M_{c}, where RE is a rare earth element selected from at least one of Pr, Nd, Dy, Tb, Ho, and Gd, T is at least one of Fe or Co, B is element B, M is at least one of Al, Cu, Ga, Ti, Zr, Nb, Mo, and V, LC is at least one of La and Ce, and a, b, c, and x are 29 wt. %≤a+x≤wt. 31%, 0.85 wt. %≤b≤1.3 wt. %, c≤5 wt. %, and 6.0 wt. %≤x≤20.0 wt. %. Independently thereof or in addition thereto, a composition of alloy R2 can be set to REₐT_{(1-abc)}B_{b}M_{c}, where RE is a rare earth element selected from at least one of Pr, Nd, Dy, Tb, Ho, and Gd, T is at least one of Fe or Co, B is element B, M is at least one of Al, Cu, Ga, Ti, Zr, Nb, Mo, and V, and a, b, and c are 33.1 wt. %≤a≤wt. 35%, 0.85 wt. %≤b≤1.3 wt. %, and c: 5 wt. %. Preferably, RE is at least one of Nd or Pr.

Preferably, RE in alloy R1 and/or in alloy R2 is at least one of Nd and Pr. It is further preferred, when M in alloy R1 and/or in alloy R2 is at least one of Al, Cu, Ga, and Ti.

It has been found that the above settings of alloy R1 and/or alloy R2 ensure a suitable concentration gradient of rare earth elements, and a Nd(Pr)-rich phase can be easily formed on the outer sphere of Ce(La)-containing grains.

According to another embodiment, which may be combined with any one the afore-mentioned embodiments, in step S3, a mixing ratio of the powder of alloy R1 and the powder of alloy R2 is in the range of 0.8 to 1.2 by weight, preferably in the range of 0.95 to 1.05 by weight, in particular 1:1 by weight.

According to another embodiment, which may be combined with any one the afore-mentioned embodiments, an average particle size D50 of the powder of alloy R1 is 2.0 to 10 μm, in particular 3.1 to 5.5 μm, and an average particle size D50 of the powder of alloy R2 is 0.5 to 5 μm, in particular 1.0 to 3.6 μm. The limitation of the average particles sizes leads to an improved coating effect. The average particle diameter (D50) of the particles may be measured by laser diffraction (LD). The method may be performed according to ISO 13320-1. According to the IUPAC definition, the equivalent diameter of a non-spherical particle is equal to a diameter of a spherical particle that exhibits identical properties to that of the investigated non-spherical particle.

### Example 1

R1 and R2 alloy flakes were separately prepared by a strip casting process using a vacuum induction furnace.

The composition of the R1 alloy was: Nd being present 23.00 wt. %, Ce being present 6.00 wt. %, B being present 0.95 wt. %, Co being present 1.00 wt. %, Al being present 0.60 wt. %, Cu being present 0.15 wt. %, Ga being present 0.40 wt. %, Ti being present 0.15 wt. %, and Fe being present as a balance, and unavoidable impurities.

The composition of R2 alloy was: Pr being present 35.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

R1 and R2 alloy flakes are separately put into a hydrogen treatment furnace for normal hydrogen absorption and dehydrogenation treatment. Then the R1 alloy was pulverized into a powder with an average particle size of 5.5 μm and the R2 alloy was pulverized into a powder with an average particle size of 3.6 μm. Both R1 and R2 alloy were pulverized by jet milling.

The R1 and R2 alloy powders were mixed with a weight ratio of 1:1. Then the mixing powders was orderly subjected to molding and orientation, and cold isostatic pressing to obtain s green compact. The green compact was put into vacuum furnace for sintering at 1030° C. for a duration time of 5 hours and thereafter cooled to room temperature. The sintered magnet was again heated to 850° C. with a duration time 3 hours and then cooled down to room temperature. Finally, the magnet was heated to 500° C. for a duration time of 3 hours during the annealing treatment.

### Example 2

R1 and R2 alloy flakes were separately prepared by strip casting process using a vacuum induction furnace.

The composition of R1 alloy was: Nd being present 8.80 wt. %, Pr being present 2.20 wt. %, Ce being present 10.00 wt. %, La being present 10.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

The composition of R2 alloy was: Nd being present 26.50 wt. %, Pr being present 6.60 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

R1 and R2 alloy flakes are separately put into a hydrogen treatment furnace for normal hydrogen absorption and dehydrogenation treatment. Then the R1 alloy was pulverized into a powder with an average particle size of 3.1 μm and the R2 alloy was pulverized into a powder with an average particle size of 1.0 μm. Both R1 and R2 alloy were pulverized by jet milling.

The R1 and R2 alloy powders were mixed with a weight ratio of 1:1. Then the mixing powders was orderly subjected to molding and orientation, and cold isostatic pressing to obtain s green compact. The green compact was put into vacuum furnace for sintering at 1030° C. for a duration time of 5 hours and thereafter cooled to room temperature. The sintered magnet was again heated to 850° C. with a duration time 3 hours and then cooled down to room temperature. Finally, the magnet was heated to 500° C. for a duration time of 3 hours during the annealing treatment.

### Example 3

R1 and R2 alloy flakes were separately prepared by strip casting process using a vacuum induction furnace.

The composition of R1 alloy was: Pr being present 18.00 wt. %, La being present 12.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

The composition of R2 alloy was: Nd being present 34.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

R1 and R2 alloy flakes are separately put into a hydrogen treatment furnace for normal hydrogen absorption and dehydrogenation treatment. Then the R1 alloy was pulverized into a powder with an average particle size of 4.0 μm and the R2 alloy was pulverized into a powder with an average particle size of 2.0 μm. Both R1 and R2 alloy were pulverized by jet milling.

The R1 and R2 alloy powders were mixed with a weight ratio of 1:1. Then the mixing powders was orderly subjected to molding and orientation, and cold isostatic pressing to obtain s green compact. The green compact was put into vacuum furnace for sintering at 1030° C. for a duration time of 5 hours and thereafter cooled to room temperature. The sintered magnet was again heated to 850° C. with a duration time 3 hours and then cooled down to room temperature. Finally, the magnet was heated to 500° C. for a duration time of 3 hours during the annealing treatment.

The rare earth element contents of R1 alloy and R2 alloy of the Examples 1 to 3 are summarized in Table 1, and particle sizes of alloy powder and final magnet properties are summarized in Table 2.

TABLE 1
rare earth element contents

| | | | | | | | | | | Total rare | La + Ce |
|---|---|---|---|---|---|---|---|---|---|---|---|
| | Content of R1 (wt. %) | | | | | | | | | earth after | after |
| | | | | | Total rare | | Content of R2 (wt. %) | | | mixing | mixing |
| | Pr | Nd | La | Ce | earth | La + Ce | Pr | Nd | Pr + Nd | (wt. %) | (wt. %) |
| Example 1 | 0.00 | 23.00 | 0.00 | 6.00 | 29.00 | 6.00 | 35.00 | 0.00 | 35.00 | 32.00 | 3.00 |
| Example 2 | 2.20 | 8.80 | 10.00 | 10.00 | 31.00 | 20.00 | 6.60 | 26.50 | 33.10 | 32.05 | 10.00 |
| Example 3 | 18.00 | 0.00 | 12.00 | 0.00 | 30.00 | 12.00 | 0.00 | 34.00 | 34.00 | 32.00 | 6.00 |

TABLE 2
particle size of alloy powders and magnet properties

| Particle size | | | magnet properties | | |
|---|---|---|---|---|---|
| R1 (μm) | R2 (μm) | R2/R1 | Br(T) | Hcj(kA/m) | Hk/Hcj |
| 5.5 | 3.6 | 0.654 | 1.245 | 1540 | 0.97 |
| 3.1 | 1.0 | 0.322 | 1.205 | 1284 | 0.95 |
| 4.0 | 2.0 | 0.500 | 1.243 | 1357 | 0.97 |

### Comparative Example 1

R1 and R2 alloy flakes were separately prepared by strip casting process using a vacuum induction furnace.

The composition of R1 alloy was: Nd being present 23.00 wt. %, Ce being present 6.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

The composition of R2 alloy was: Pr being present 35.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

R1 and R2 alloy flakes are separately put into a hydrogen treatment furnace for normal hydrogen absorption and dehydrogenation treatment. Then the R1 alloy was pulverized into a powder with an average particle size of 3.6 μm and the R2 alloy was pulverized into a powder with an average particle size of 3.6 μm. Both R1 and R2 alloy were pulverized by jet milling.

The R1 and R2 alloy powders were mixed with a weight ratio of 1:1. Then the mixing powders was orderly subjected to molding and orientation, and cold isostatic pressing to obtain s green compact. The green compact was put into vacuum furnace for sintering at 1030° C. for a duration time of 5 hours and thereafter cooled to room temperature. The sintered magnet was again heated to 850° C. with a duration time 3 hours and then cooled down to room temperature. Finally, the magnet was heated to 500° C. for a duration time of 3 hours during the annealing treatment.

### Comparative Example 2

R1 and R2 alloy flakes were separately prepared by strip casting process using a vacuum induction furnace.

The composition of R1 alloy was: Nd being present 26.00 wt. %, Ce being present 6.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

The composition of R2 alloy was: Pr being present 32.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

R1 and R2 alloy flakes are separately put into a hydrogen treatment furnace for normal hydrogen absorption and dehydrogenation treatment. Then the R1 alloy was pulverized into a powder with an average particle size of 5.5 μm and the R2 alloy was pulverized into a powder with an average particle size of 3.6 μm. Both R1 and R2 alloy were pulverized by jet milling.

R1 and R2 alloy flakes are separately put into a hydrogen treatment furnace for normal hydrogen absorption and dehydrogenation treatment. Then R1 alloy was pulverized into powder with an average particle size of 5.5 μm. And R2 alloy was pulverized into powder with average particle size 3.6 μm.

The R1 and R2 alloy powders were mixed with a weight ratio of 1:1. Then the mixing powders was orderly subjected to molding and orientation, and cold isostatic pressing to obtain s green compact. The green compact was put into vacuum furnace for sintering at 1030° C. for a duration time of 5 hours and thereafter cooled to room temperature. The sintered magnet was again heated to 850° C. with a duration time 3 hours and then cooled down to room temperature. Finally, the magnet was heated to 500° C. for a duration time of 3 hours during the annealing treatment.

### Comparative Example 3

R1 and R2 alloy flakes were separately prepared by strip casting process using vacuum induction furnace.

The composition of R1 alloy was: Nd being present 7.20 wt. %, Pr being present 1.80 wt. %, Ce being present 11.00 wt. %, La being present 11.00 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

The composition of R2 alloy was: Nd being present 26.50 wt. %, Pr being present 6.60 wt. %, B being present 0.95 wt. %, Co being present 1.0 wt. %, Al being present 0.60 wt. %, Cu being present 0.15 wt. %, Ga being present 0.40 wt. %, Ti being present 0.15 wt. %, and Fe being present as a balance, and unavoidable impurities.

R1 and R2 alloy flakes are separately put into a hydrogen treatment furnace for normal hydrogen absorption and dehydrogenation treatment. Then the R1 alloy was pulverized into a powder with an average particle size of 3.1 μm and the R2 alloy was pulverized into a powder with an average particle size of 1.0 μm. Both R1 and R2 alloy were pulverized by jet milling.

The R1 and R2 alloy powders were mixed with a weight ratio of 1:1. Then the mixing powders was orderly subjected to molding and orientation, and cold isostatic pressing to obtain s green compact. The green compact was put into vacuum furnace for sintering at 1030° C. for a duration time of 5 hours and thereafter cooled to room temperature. The sintered magnet was again heated to 850° C. with a duration time 3 hours and then cooled down to room temperature. Finally, the magnet was heated to 500° C. for a duration time of 3 hours during the annealing treatment.

The rare earth element contents of R1 alloy and R2 alloy of the Comparative Examples 1 to 3 are summarized in Table 3, and particle sizes of alloy powder and final magnet properties are summarized in Table4.

TABLE 3
rare earth element content in comparative examples

| | | | | | | | | | | Total rare | La + Ce |
|---|---|---|---|---|---|---|---|---|---|---|---|
| | Content of R1 (wt. %) | | | | | | | | | earth after | After |
| | | | | | Total rare | | Content of R2 (wt. %) | | | mixing | mixing |
| | Pr | Nd | La | Ce | earth | La + Ce | Pr | Nd | Pr + Nd | (wt. %) | (wt. %) |
| Comparative | 0.00 | 23.00 | 0.00 | 6.00 | 29.00 | 6.00 | 35.00 | 0.00 | 35.00 | 32.00 | 3.0 |
| Example 1 | | | | | | | | | | | |
| Comparative | 0.00 | 26.00 | 0.00 | 6.00 | 32.00 | 6.00 | 32.00 | 0.00 | 32.00 | 32.00 | 3.0 |
| Example 2 | | | | | | | | | | | |
| Comparative | 1.80 | 7.20 | 11.00 | 11.00 | 31.00 | 22.00 | 6.60 | 26.50 | 33.10 | 32.05 | 11.0 |
| Example 3 | | | | | | | | | | | |

TABLE 4
particle size of alloy powders and magnet properties

| Particle size | | | Magnet properties | | |
|---|---|---|---|---|---|
| R1 (μm) | R2 (μm) | R2/R1 | Br(T) | Hcj(kA/m) | Hk/Hcj |
| 3.6 | 3.6 | 1.000 | 1.238 | 1467 | 0.97 |
| 5.5 | 3.6 | 0.654 | 1.234 | 1454 | 0.96 |
| 3.1 | 1.0 | 0.322 | 1.163 | 1108 | 0.89 |

The alloys of Example 1 and Comparative Example 1 had the same composition. The R1 and R2 alloy powders of Example 1 had an average particle size of 5.5 μm and 3.6 μm, respectively. The particle size deviation promoted the formation of a coating structure of R1 and R2 grains, which induced higher magnetic properties. When the particle size is equal, as in Comparative Example 1, it is difficult to form the coating structure of Nd or Pr and a hard magnetic layer was difficult to form outside the La or Ce contained grains during the sintering and annealing steps.

The R1 and R2 alloy powders of Example 1 and Comparative Example 2 had the same average particle size distribution. But the R2 alloy in Comparative Example 2 had a lower total rare earth content compared with Example 1. There was less Nd/Pr-rich phase in the R2 powders. Although a coating structure can be formed by mixing R1 and R2 powders, a hard magnetic layer was difficult to be formed due to lack of the Nd/Pr-rich phase outside the La/Ce contained grains during sintering and annealing steps.

Samples of Comparative Examples 3 had lower magnetic properties due to a higher content of La/Ce. A higher proportion of La/Ce may also easy generate impurities in the main phase.

1. A method for preparing NdFeB magnets including Ce and/or La, the method including the steps of:
S1) Separately preparing flakes of alloy R1 and flakes of alloy R2 each by a strip casting process, wherein the alloy R1 includes at least one of La and Ce, but the alloy R2 does not include La and Ce;
S2) separately subjecting the flakes of alloy R1 and the flakes of alloy R2 to a hydrogen embrittlement process followed by pulverizing the process product to alloy powders by jet milling, wherein a ratio of the average particle sizes D50 of the powder of alloy R1 and the powder of alloy R2 satisfied formula: 0.32≤R2/R1≤0.66;
S3) mixing the powder of alloy R1 and the powder of alloy R2; and
S4) subjecting the mixed powders to molding and magnetic field orientation, cold isostatic pressing, sintering, and an annealing process.

2. The method of claim 1, wherein a total content of La and Ce in alloy R1 is 6.0 to 20.0 wt. %.

3. The method of claim 1, wherein a total content of rare earth elements in alloy R1 is 29.0 to 31.0 wt. %.

4. The method of claim 2, wherein a total content of rare earth elements in alloy R1 is 29.0 to 31.0 wt. %.

5. The method of claim 1, wherein a total content of rare earth elements in alloy R2 is 33.10 to 35.00 wt. %.

6. The method of claim 2, wherein a total content of rare earth elements in alloy R2 is 33.10 to 35.00 wt. %.

7. The method of claim 3, wherein a total content of rare earth elements in alloy R2 is 33.10 to 35.00 wt. %.

8. The method of claim 4, wherein a total content of rare earth elements in alloy R2 is 33.10 to 35.00 wt. %.

9. The method of claim 1, wherein a composition of alloy R1 is set to REₐLC_{X}T_{(1-abc)}B_{b}M_{c}, where RE is a rare earth element selected from at least one of Pr, Nd, Dy, Tb, Ho, and Gd, T is at least one of Fe or Co, B is element B, M is at least one of Al, Cu, Ga, Ti, Zr, Nb, Mo, and V, LC is at least one of La and Ce, and a, b, c, and x are 29 wt. % a+x≤wt. 31%, 0.85 wt. %≤b≤1.3 wt. %, c≤5 wt. %, and 6.0 wt. % x≤20.0 wt. %; and/or a composition of alloy R2 is set to REₐT_{(1-abc)}B_{b}M_{c}, where RE is a rare earth element selected from at least one of Pr, Nd, Dy, Tb, Ho, and Gd, T is at least one of Fe or Co, B is element B, M is at least one of Al, Cu, Ga, Ti, Zr, Nb, Mo, and V, and a, b, and c are 33.1 wt. %≤a≤wt. 35%, 0.85 wt. %≤b≤1.3 wt. %, and c≤5 wt. %.

10. The method of claim 9, wherein RE in alloy R1 and/or in alloy R2 is at least one of Nd and Pr.

11. The method of claim 9, wherein M in alloy R1 and/or in alloy R2 is at least one of Al, Cu, Ga, and Ti.

11. (canceled)

12. The method of claim 1, wherein an average particle size D50 of the powder of alloy R1 is 2.0 to 10 μm and an average particle size D50 of the powder of alloy R2 is 0.5 to 5.0 μm, measured by laser diffraction (LD).

13. The method of claim 2, wherein an average particle size D50 of the powder of alloy R1 is 2.0 to 10 μm and an average particle size D50 of the powder of alloy R2 is 0.5 to 5.0 μm, measured by laser diffraction (LD).

14. The method of claim 3, wherein an average particle size D50 of the powder of alloy R1 is 2.0 to 10 μm and an average particle size D50 of the powder of alloy R2 is 0.5 to 5.0 μm, measured by laser diffraction (LD).

15. The method of claim 4, wherein an average particle size D50 of the powder of alloy R1 is 2.0 to 10 μm and an average particle size D50 of the powder of alloy R2 is 0.5 to 5.0 μm, measured by laser diffraction (LD).

16. The method of claim 5, wherein an average particle size D50 of the powder of alloy R1 is 2.0 to 10 μm and an average particle size D50 of the powder of alloy R2 is 0.5 to 5.0 μm, measured by laser diffraction (LD).

17. The method of claim 9, wherein an average particle size D50 of the powder of alloy R1 is 2.0 to 10 μm and an average particle size D50 of the powder of alloy R2 is 0.5 to 5.0 μm, measured by laser diffraction (LD).

18. The method of claim 1, wherein, in step S3, a mixing ratio of the powder of alloy R1 and the powder of alloy R2 is in the range of 0.8 to 1.2 by weight.

19. The method of claim 2, wherein, in step S3, a mixing ratio of the powder of alloy R1 and the powder of alloy R2 is in the range of 0.8 to 1.2 by weight.

20. The method of claim 3, wherein, in step S3, a mixing ratio of the powder of alloy R1 and the powder of alloy R2 is in the range of 0.8 to 1.2 by weight.
